(19) United States
(12) Patent Application Publication
(10) Pub. No.: US 2026/0183925 A1
(43) Pub. Date: Jul. 2, 2026

(54) MULTI-REGION ERGONOMIC POWER TOOL AND HANDGRIP

(71) Applicant: Apex Brands, Inc., Apex, NC (US)

(72) Inventors: Scott Daniel Bublitz, Denver, NC (US); Brian Robert Butler, Charlotte, NC (US)

(21) Appl. No.: 19/130,709

(22) PCT Filed: Aug. 21, 2023
(86) PCT No.: PCT/US2023/030673

§ 371 Date: May 16, 2025

Related U.S. Application Data
(60) Provisional application No. 63/426,063, filed on Nov. 17, 2022.

(51) Int. Cl. B25F 5/02; B25B 21/00

(52) U.S. Cl. CPC B25F 5/02; B25B 21/00

(57) ABSTRACT

A power tool includes a body defining a drive axis, a handgrip extending from the body and defining a handgrip axis, and a depressible trigger. The handgrip defines an index finger cross-sectional portion associate with the trigger, a middle finger cross-sectional portion, a ring finger cross-sectional portion, and a little finger cross-sectional portion. The cross-sectional portions may be defined by various ellipses or partial ellipses that are optimized for hand-sizes in certain geographies.

### CROSS-REFERENCE TO RELATED APPLICATIONS

This application claims priority under 35 U.S.C. § 119(e) to U.S. Provisional Application No. 63/426,063, filed Nov. 17, 2022, both of which are expressly incorporated by reference herein in their entirety.

### TECHNICAL FIELD

Example embodiments generally relate to power tools and, in particular, relate to ergonomic technologies in the area of power tools.

### BACKGROUND

Use of power tools often involves precise control and repetitive motions. Since such operating requirements can often result in user fatigue, it is beneficial to improve the user experience through ergonomics. Ergonomics is the applied science of studying human factors, such as anatomies, and designing human interfaces that improve efficiency, comfort, and safety. In power tool design, handles and grips are common interfaces that can benefit from ergonomic design. However, a design that is tailored to one individual may not meet the ergonomic requirements of another individual due to anatomical differences that may be present between the individuals. As such, it is desirable to consider ergonomics in the power tool space based on a various differences in individual users across a broad population.

### BRIEF SUMMARY OF SOME EXAMPLES

According to some example embodiments, a power tool is provided. The power tool may comprise a body configured to house a motor and a drive head rotationally coupled to the motor. The drive head may be rotatable about a drive axis. The drive head may also be disposed on a front of the power tool, and the power tool may have a back, which is disposed opposite of the front. The power tool may further comprise a handgrip extending from a bottom of the body and a grip top along a handgrip axis to a grip bottom. The handgrip axis may intersect with the drive axis, and the handgrip may have a grip front facing the front, a grip back facing the back, a first grip side disposed between the grip front and the grip back, and a second grip side disposed between the grip front and the grip back and opposite the first grip side. The handgrip axis may extend at an oblique angle to the drive axis. The power tool may further comprise a trigger configured to be depressible between an extended position and a depressed position by an index finger such that the trigger actuates along a trigger actuating direction that is substantially parallel to the drive axis and intersects with the handgrip axis. The handgrip may comprise an index finger cross-sectional portion at the grip top, with the trigger being disposed within the index finger cross-sectional portion. The handgrip may further comprise a middle finger cross-sectional portion disposed below the index finger cross-sectional portion, a ring finger cross-sectional portion disposed below the middle finger cross-sectional portion, and a little finger cross-sectional portion disposed below the ring finger cross-sectional portion. The handgrip may have a partial ellipse shape at an index finger cross-section taken through the trigger and parallel to the drive axis in the index finger cross-sectional portion. The partial ellipse shape may have a partial ellipse shape minor axis length that is within a range of about 29 millimeters (mm) to 33 mm. The handgrip may have a first ellipse shape at a middle finger cross-section taken perpendicular to the handgrip axis in the middle finger cross-sectional portion. The first ellipse shape may have a first ellipse shape minor axis length that is greater than the partial ellipse shape minor axis length. The handgrip may also have a second ellipse shape at a ring finger cross-section taken perpendicular to the handgrip axis in the ring finger cross-sectional portion. The second ellipse shape may have a second ellipse shape minor axis length that is greater than the partial ellipse shape minor axis length and less than the first ellipse shape minor axis length. The handgrip may have a third ellipse shape at a little finger cross-section taken perpendicular to the handgrip axis in the little finger cross-sectional portion. The third ellipse shape may have a third ellipse shape minor axis length that is less than the first ellipse shape minor axis length and the second ellipse shape minor axis length.

According to some example embodiments, a power tool is provide that comprises a body configured to house a motor and a drive head rotationally coupled to the motor. The drive head may be rotatable about a drive axis, and the drive head may be disposed on a front of the power tool. The power tool may also have a back, which is disposed opposite of the front. The power tool may comprise a handgrip extending from a bottom of the body and a grip top along a handgrip axis to a grip bottom. The handgrip axis may intersect with the drive axis, and the handgrip may have a grip front facing the front, a grip back facing the back, a first grip side disposed between the grip front and the grip back, and a second grip side disposed between the grip front and the grip back and opposite the first grip side. The handgrip axis may extend at an oblique angle to the drive axis. The power tool may also comprise a trigger configured to be depressible between an extended position and a depressed position by an index finger such that the trigger actuates along a trigger actuating direction that is substantially parallel to the drive axis and intersects with the handgrip axis. A trigger-depressed length from the trigger to an apex of the partial ellipse shape opposite the trigger may be about 48 millimeters (mm) to 52 mm. A trigger extended distance from the trigger to the apex of the partial ellipse shape opposite the trigger is about 53 mm to 57 mm. A width of the trigger may be between about 16 mm to 20 mm, and a trigger height of the trigger may be about 24 mm to 28 mm. A trigger vertical concave radius of curvature of a finger engaging front surface of the trigger may be about 18 mm to 22 mm.

According to some example embodiments, another power tool is provided. The power tool may comprise a body configured to house a motor and a drive head rotationally coupled to the motor. The drive head may be rotatable about a drive axis, and the drive head may be disposed on a front of the power tool with an opposite face being a back of the power tool. The power tool may also comprise a handgrip extending from a bottom of the body and a grip top along a handgrip axis to a grip bottom. The handgrip axis may intersect with the drive axis, and the handgrip may have a grip front facing the front, a grip back facing the back, a first grip side disposed between the grip front and the grip back, and a second grip side disposed between the grip front and the grip back and opposite the first grip side. The handgrip axis may extend at an oblique angle to the drive axis. The power tool may further comprise a trigger configured to be depressible between an extended position and a depressed position by an index finger such that the trigger actuates along a trigger actuating direction that is substantially parallel to the drive axis and intersects with the handgrip axis. The handgrip may comprise an index finger cross-sectional portion at the grip top. The trigger may be disposed within the index finger cross-sectional portion. The handgrip may further comprise a middle finger cross-sectional portion disposed below the index finger cross-sectional portion, a ring finger cross-sectional portion disposed below the middle finger cross-sectional portion, and a little finger cross-sectional portion disposed below the ring finger cross-sectional portion. A grip front upper concave radius of curvature of a front surface of the handgrip within the middle finger cross-sectional portion is about 8 mm and 12 mm. A grip back upper concave radius of curvature of a back surface of the handgrip within the index finger cross-sectional portion is between about 12 mm and 16 mm.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1A is a table of hand length measurements across populations of individuals in different geographic regions according to an example embodiment;

FIG. 1B is a table of some example determined tool handle or handgrip dimensions for populations of individuals in different geographic regions according to an example embodiment;

FIG. 1C is a table of relative finger length according to an example embodiment;

FIG. 1D is a table of current product handle circumferences and diameters;

FIG. 2A illustrates a side view of an example rotating power tool according to some example embodiments;

FIG. 2B illustrates a side view of an example rotating power tool with indications of defined finger-based cross-sectional portions on a handgrip according to some example embodiments;

FIG. 2C illustrates a front view of an example rotating power tool with indications of defined finger-based cross-sectional portions on a handgrip according to some example embodiments;

FIG. 2D illustrates a side view of an example rotating power tool with indications of areas of curvature on a handgrip according to some example embodiments;

FIG. 2E illustrates a front view of an example rotating power tool with indications of areas of curvature on a handgrip according to some example embodiments;

FIG. 3A illustrates a side view of an example handgrip according to some example embodiments;

FIG. 3B illustrates a front view of an example handgrip according to some example embodiments;

FIG. 3C illustrates a side view of an example handgrip in association wherein the bone structure of a hand according to some example embodiments;

FIG. 3D illustrates a side view of an example handgrip with indications of defined finger-based cross-sectional portions according to some example embodiments;

FIG. 3E illustrates a front view of an handgrip with indications of defined finger-based cross-sectional portions according to some example embodiments;

FIG. 3F illustrates a side view of an example trigger according to some example embodiments;

FIG. 3G illustrates a top view of an example trigger according to some example embodiments;

FIG. 3H illustrates a side view of an example handgrip with indications of defined finger-based cross-sections with a trigger in an extended position according to some example embodiments;

FIG. 3I illustrates a side view of an example handgrip with an indications of a defined finger-based cross-section with a trigger in a depressed position according to some example embodiments;

FIG. 3J illustrates a cross-section of the handgrip shown in FIG. 3H taken at IO-IO according to some example embodiments;

FIG. 3K illustrates a cross-section of the handgrip shown in FIG. 3I taken at IC-IC according to some example embodiments;

FIG. 3L illustrates a cross-section of the handgrip shown in FIG. 3H taken at M-M according to some example embodiments;

FIG. 3M illustrates a cross-section of the handgrip shown in FIG. 3H taken at R-R according to some example embodiments;

FIG. 3N illustrates a cross-section of the handgrip shown in FIG. 3H taken at L-L according to some example embodiments;

FIG. 3O illustrates a side view of an example handgrip with indications of areas of curvature according to some example embodiments; and

FIG. 3P illustrates a front view of an example handgrip with indications of areas of curvature according to some example embodiments.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other. As used herein, the term “about” with reference to a measurement is intended to mean the measurement itself within reasonable manufacturing tolerances, industry construction limitations, and the like.

In the development of the example embodiments of an improved ergonomic handle or handgrip for power tools, various studies were performed and referenced to determine geographic-based optimizations for sizing and feature parameters. In this regard, hand sizes and finger lengths by geographic region and gender were considered to realize efficient, comfortable, and safe handgrip parameters that would benefit a large portion of the targeted populations. Going beyond mere design-choice, statistical analyses and expert determinations were made to arrive at the various example embodiments, which offer superior ergonomics to a broad population. By analyzing and determining optimized parameters values, previous regionally tailored solutions, manufacturing, and inventory can be retired, to allow for singular ergonomic handgrip solutions that meet the needs for a broad population base. In the development of some example embodiments, a finger length (F) was determined and twenty percent of the finger length (F*0.20) was used to define a diameter (D) of an optimally sized circle for grip strength at the associated finger. The diameter (D) can then be used to define a circumference (C) of the optimally sized circle. This circumference (C) was then used to define an ellipse with an equal circumference (C) to the optimally sized circle. The ellipse would have ratio of the minor axis to the major axis of 1 to 1.25 (or 1:1.25). According to some example embodiments, the ellipse would have a ratio of the minor axis to the major axis that is within a range of about 1:1.20 to 1:1.32. This ratio in association with the circumference can provide an optimal shape for the grip strength according to some example embodiments.

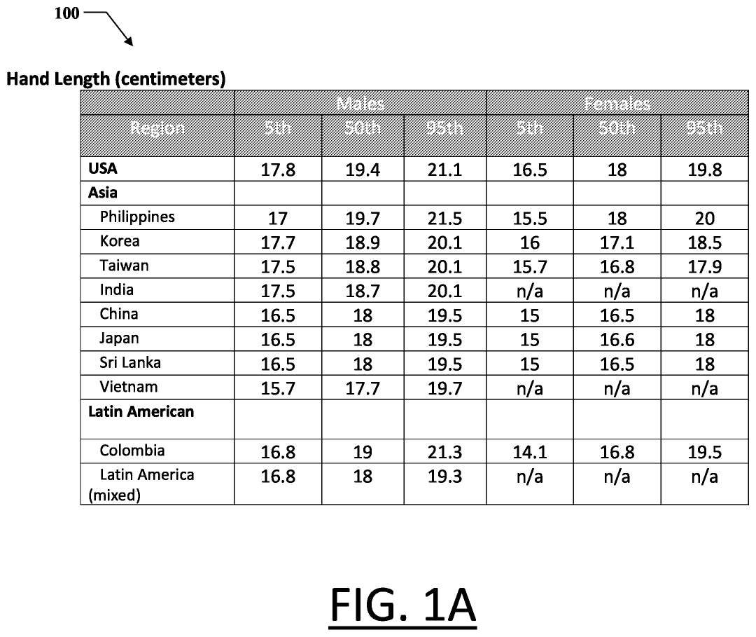

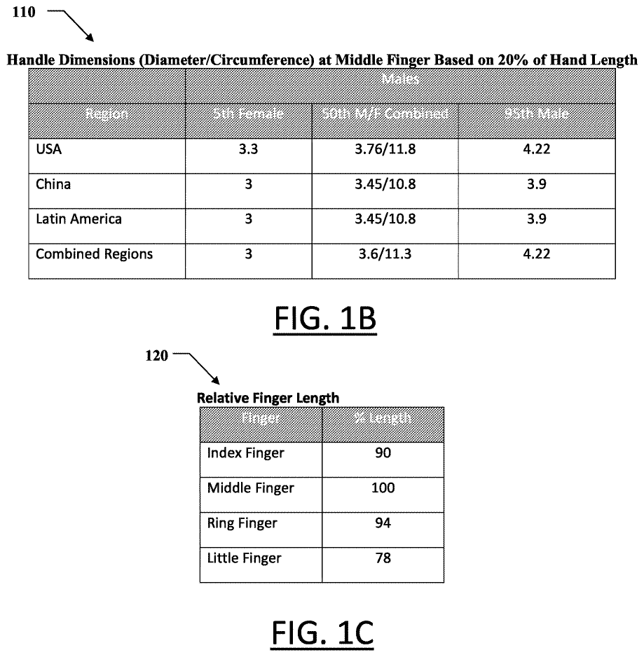

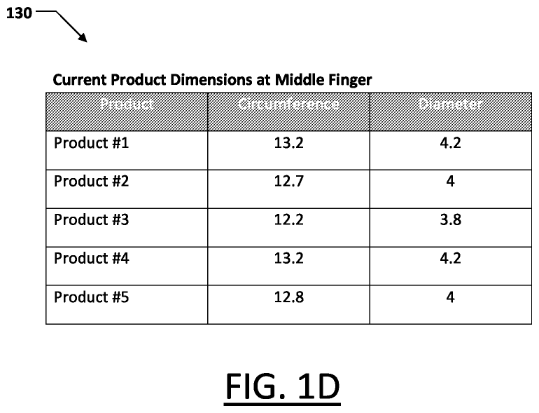

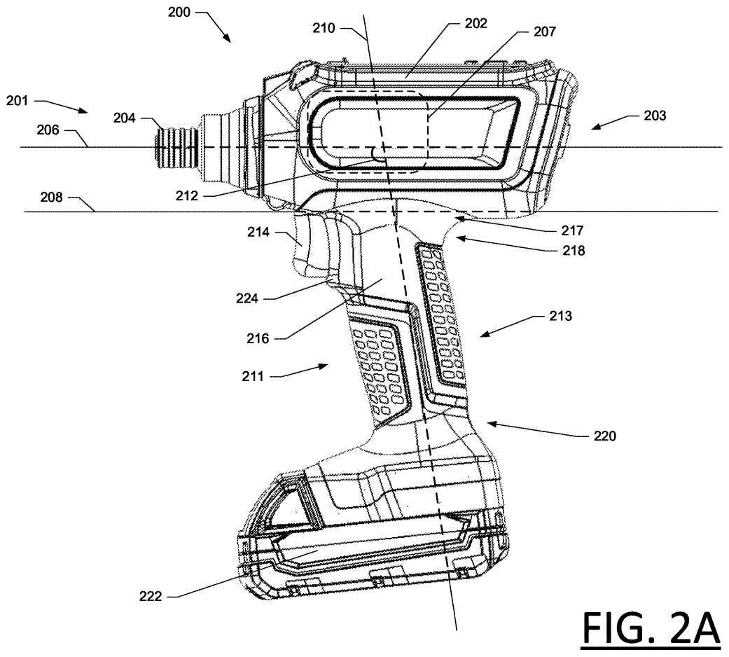

With reference to FIG. 1A, the table 100 indicates hand length measurements that were taken from populations in various geographic regions. More specifically, table 100 provides male and female hand lengths within the 5th, the 50th, and the 95th percentiles of the populations of each region. As can be seen, the ranges of hand length within each region and across the different portions of the population can illustrate the wide variety of hand sizes that can be considered when developing a broad-based ergonomic design. For example, some females in Columbia have hand lengths as small as 14.1 centimeters (cm), while some males in the Philippines have hand lengths as large as 21.5 cm. Such a range of differences in hand length requires that an ergonomic analysis and associated statistics be analyzed to develop solutions that have a broad application.

Based on the hand lengths as provided in table 100, handle or handgrip diameters and circumferences have been developed and considered for implementation in a handgrip of a power tool according to various example embodiments. In this regard, table 110 of FIG. 1B indicates candidate dimensions (e.g., diameter and circumference) for handles within select geographic regions. As an additional factor for consideration, the table 120 of FIG. 1C illustrates relative finger lengths (i.e., typical length differences between human figures) for consideration in the context of a handgrip for control and ease of use. For comparisons with the example determination made in table 110, the table 130 of FIG. 1D is provided which shows some dimensions of conventional handle solutions. In this regard, it can be seen that the conventional solutions tend to be oversized relative to the optimized solutions determined and provided in FIG. 1B.

Based on the investigations of hand sizes in various regions of the world, handgrip designs have been developed and described herein that leverage this information to develop a handgrips that offer an ergonomic feel for a range of individuals across these regions. Accordingly, various example embodiments implement strategic handgrip design parameters in combination to arrive at overall handgrip designs that provide an ergonomic feel to individuals across geographic regions to provide, for example, a single design that meets ergonomic requirements for comfortable use. Such designs have the benefit of supporting improved supply chain and inventory management, since different handgrip designs for different geographic regions are unnecessary thereby limiting the number of product offerings necessary within a catalog of products. Further, such unified designs, according to some example embodiments, can reduce the need for separate tooling of regional designs and different assembly requirements. In addition, efficiencies in design time can be realized since separate designs for separate geographic regions need not be created.

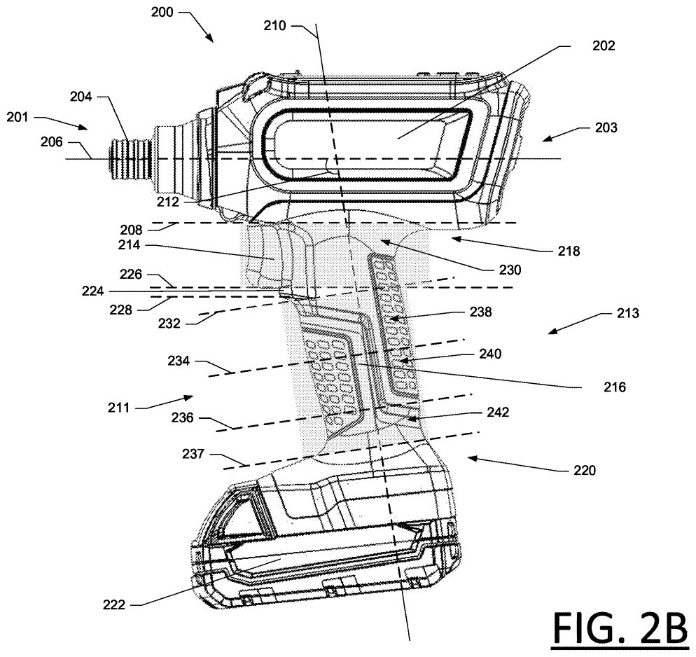

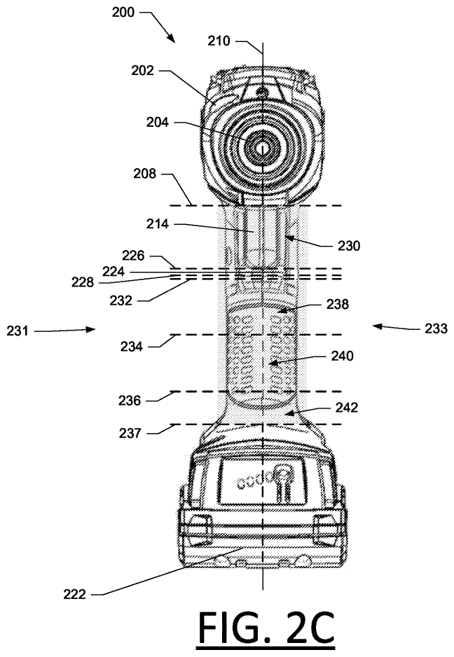

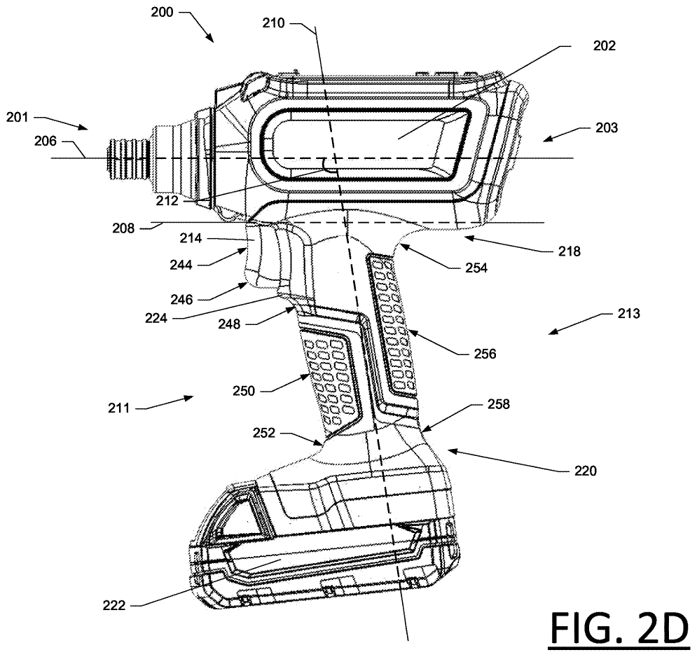

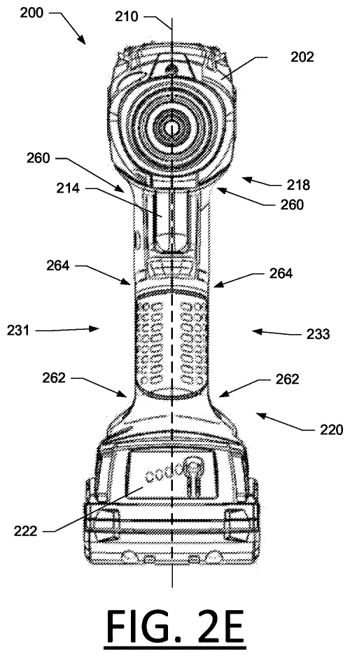

Referring now to FIG. 2A, and example power tool 200 with a handgrip 216, according to some example embodiments, is shown. FIG. 2A provides a side view of the power tool 200. In this regard, the power tool 200 may comprise a body 202, a handgrip 216, and a battery 222. The body 202 may house a motor 207, which may be an electric motor. The motor 207 may be configured to rotationally drive a drive head 204, which may be configured to rotationally drive, for example, a fastener via a bit that may be driven by the drive head 204. The drive head 204 may rotate about a drive axis 206.

The handgrip 216 may extend from the bottom 217 of the body 202 and be the primary holding interface for a user. The user may clutch or grip the handgrip 216 by wrapping the user's figures around the handgrip 216 such that a palm of the user is disposed on the grip back 213. As the primary holding interface, the primary control for the power tool 200 may be disposed on the handgrip 216 as the trigger 214. The trigger 214 may be disposed on the grip front 211 at the grip top 218 for operation via the user's index finger. According to some example embodiments, the trigger 214 may be biased (e.g., spring biased) into an extended position and the trigger 214 may be actuated by the user into a depressed position against the bias. The actuation of the trigger 214 may cause the motor 207 to operate and rotationally drive the drive head 204.

As mentioned above, the handgrip 216 may be extend from a bottom 217 of the body 202, and may extend along a handgrip axis 210 from the bottom 217 of the body 202. The handgrip axis 210 may be defined through a center of the handgrip 216. According to some example embodiments, some cross-sections of the handgrip 216 may be shaped as ellipses and the handgrip axis 210 may pass through the centers of the ellipses. According to some example embodiments, the handgrip axis 210 may extend from a center of gravity of the body 202, which may provide balance to the power tool 200 when held by the handgrip 216. Additionally, the handgrip axis 210 may intersect with the drive axis 206 at a handgrip axis angle 212. The handgrip axis angle 212 may be defined, for example, by the angle at a position that is the lower, front of the intersection of the handgrip axis 210 and the drive axis 206. According to some example embodiments, the handgrip axis angle 212 may be an oblique angle that is greater than ninety degrees. The handgrip 216 may therefore extend from the body 202 in a swept rearward configuration (or a swept towards the back 203 configuration) of the power tool 200. According to some example embodiments, the handgrip axis angle 212 may be preferably about 105 degrees, making the lower, back angle from the intersection being preferably about 75 degrees. As such, according to some example embodiments, this oblique angle formed by the drive axis 206 and the handgrip axis 210 may be about 72 degrees to 78 degrees, and preferably 75 degrees. According to some example embodiments, the handgrip axis angle 212 may be within a range from about 100 degrees to about 110 degrees.

As a guide for further structural relationships, a trigger top plane 208 may be defined. The trigger top plane 208 may be a plane defined by a top surface of the trigger 214. According to some example embodiments, the top surface of the trigger 214, even when being actuated, may remain on the trigger top plane 208. According to some example embodiments, the trigger top plane 208 may be parallel to the drive axis 206. Accordingly, the handgrip axis 210 may intersect with the trigger top plane 208 at the same angle as the handgrip axis 210 interests with the drive axis 206.

The handgrip 216 may ergonomically formed to comfortably fit within the hand of user's from different geographic regions. When gripped, the user's index finger may interface with the trigger 214 and the user's middle, ring, and little fingers may be disposed below the trigger 214 on the grip front 211. At the base or grip bottom 220, the power tool 200 may broaden to form an interface for a battery 222, and the user's little finger may be disposed adjacent to the broadening of the grip bottom 220. As mentioned above, when the user is gripping the handgrip 216, the palm of the user's hand may be disposed on the grip back 213 with the upper portion of the user's palm at the grip top 218 and the lower portion of the user's palm at the grip bottom 220 on the grip back 213. As further described below, the handgrip 216 may include various sizes, shapes, and curvatures to define an ergonomic hand interface that is designed to support the differences in hand sizes that are predominant in many geographic regions.

Now referring to FIGS. 2B and 2C, another side view and a front view of the power tool 200, respectively, are shown, however, with cross-sectional portions of the handgrip 216 defined. In this regard, an index finger cross-sectional portion 230, a middle finger cross-sectional portion 238, a ring finger cross-sectional portion 240, and a little finger cross-sectional portion 242 are defined. These cross-sectional portions are shown within the side view of FIG. 2B relative the grip front 211 and grip back 213, and within the front view of FIG. 2C relative to a first grip side 231 (disposed between the grip front 211 and the grip back 213) and a second grip side 233, opposite the first grip side 231.

The index finger cross-sectional portion 230 may be defined as a volume of the handgrip 216 that is between the trigger top plane 208 and a trigger bottom plane 226. Having defined the trigger top plane 208 above, the trigger bottom plane 226 may be a plane through the handgrip 216 that is aligned with a bottom surface of the trigger 214. According to some example embodiments, the bottom surface of the trigger 214 may be disposed parallel to the drive axis 206, and, as such, the index finger cross-sectional portion 230 may be generally parallel to the drive axis 206.

On the grip front 211 below the trigger 214, the handgrip 216 may include a trigger transition protrusion 224. The trigger transition protrusion 224 may be a protruding static member that extends in a forward direction immediately adjacent to the bottom surface of the trigger 214. The trigger transition protrusion 224 may operate to prevent the user's middle finger from resting on the bottom surface of the trigger 214 and potentially being pinched when the user actuates the trigger 214. As such, the user's middle finger may rest on the bottom side of the trigger transition protrusion 224 to prevent the user's middle finger from touching the trigger 214 when the user is gripping the handgrip 216. A front face of the trigger transition protrusion 224 may extend from the trigger bottom plane 226 to a bottom surface of the trigger transition protrusion 224 to define a trigger transition bottom plane 228 that is generally parallel to the drive axis 206. The height of the trigger transition protrusion 224 may be preferably about 2 millimeters (mm), but may be within a range of about 1 mm to 3 mm.

Intersecting with the trigger transition bottom plane 228 and disposed below the front face of the of the trigger transition protrusion 224, a middle finger top plane 232 may be defined that is perpendicular or orthogonal to the handgrip axis 210. Based on the research described above, a middle finger diameter may be selected to be about 25 mm. As such, about 25 mm below the middle finger top plane 232, a ring finger top plane 234 (or the middle finger bottom plane) may be defined that is also perpendicular or orthogonal to handgrip axis 210. The volume of the handgrip 216 between the middle finger top plane 232 and the ring finger top plane 234 may define the middle finger cross-sectional portion 238.

Additionally, a ring finger diameter may be selected to be about 24 mm. As such, about 24 mm below the ring finger top plane 234, a little finger top plane 236 (or the ring finger bottom plane) may be defined that is also perpendicular or orthogonal to handgrip axis 210. The volume of the handgrip 216 between the ring finger top plane 234 and the little finger top plane 236 may define the ring finger cross-sectional portion 240.

Additionally, a little finger diameter may be selected to be about 21 mm. As such, about 21 mm below the little finger top plane 236, a handgrip bottom plane 237 may be defined that is also perpendicular or orthogonal to handgrip axis 210. The volume of the handgrip 216 between the little finger top plane 236 and the handgrip bottom plane 237 may define the little finger cross-sectional portion 242.

Now referring to FIGS. 2D and 2E, a side view and a front view of the power tool 200, respectively, are shown with reference to various curvature parameters of the handgrip 216. In this regard, with reference to FIG. 2D, curvatures of the grip front 211 and the grip back 213 are defined. The trigger 214 may have a trigger vertical radius of curvature 244 on the front face of the trigger 214 that extends from a top of the trigger 214 to a bottom of the trigger 214. Additionally, according to some example embodiments, the front face of the trigger 214 may have rounded ends that have trigger end radii of curvature 246.

Additionally, on the grip front 211 and on the bottom side of the trigger transition protrusion 224, a concave rounded portion is defined that has a grip front upper radius of curvature 248. Also on the grip front 211 and at the grip bottom 220, a concave curvature is defined at the transition to the battery interface with that curvature being defined as the grip front lower radius of curvature 252. Further, a convex curvature is defined on a middle portion of the grip front 211 that is referred to as the grip front middle radius of curvature 250.

On the grip back 213 and on the bottom side of the transition from the body 202 at the grip top 218, a concave rounded portion is defined that has a grip back upper radius of curvature 254. Also on the grip back 213 and at the grip bottom 220, a concave curvature is defined at the transition to the battery interface with that curvature being defined as the grip back lower radius of curvature 258. Further, a convex curvature is defined on a middle portion of the grip back 213 that is referred to as the grip back middle radius of curvature 256.

Referring to FIG. 2E, curvatures on the sides of the handgrip 216 may be defined. In this regard, the handgrip 216 may have bilateral symmetry, according to some example embodiments, such that the curvatures on the first grip side 231 may be the same as the curvatures to the second grip side 233 relative to the front 201 and the handgrip axis 210. In this regard, the grip sides may define a grip side upper radius of curvature 260 at the grip top 218 that is concave. Additionally, at the grip bottom 220, the grip sides may define a grip side lower radius of curvature 262 that is concave. Further, a convex curvature is defined on a middle portion of the grip sides 231, 233 that is referred to as the grip side middle radius of curvature 264.

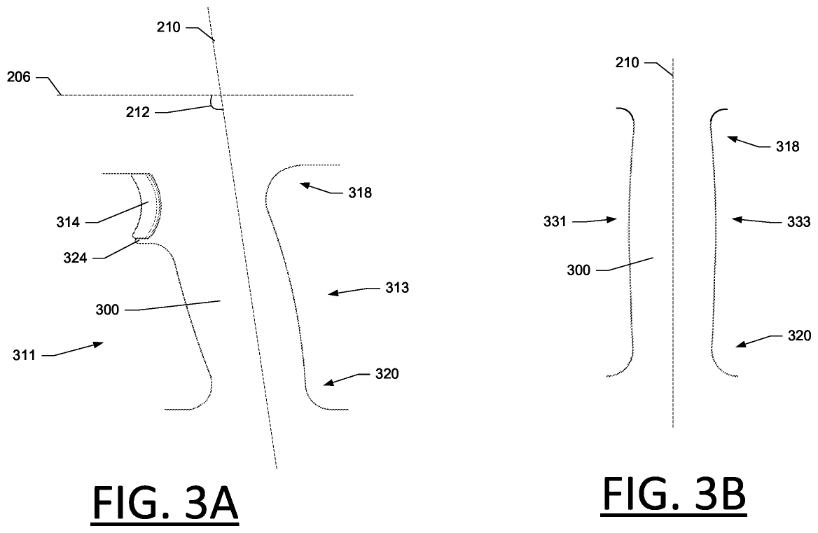

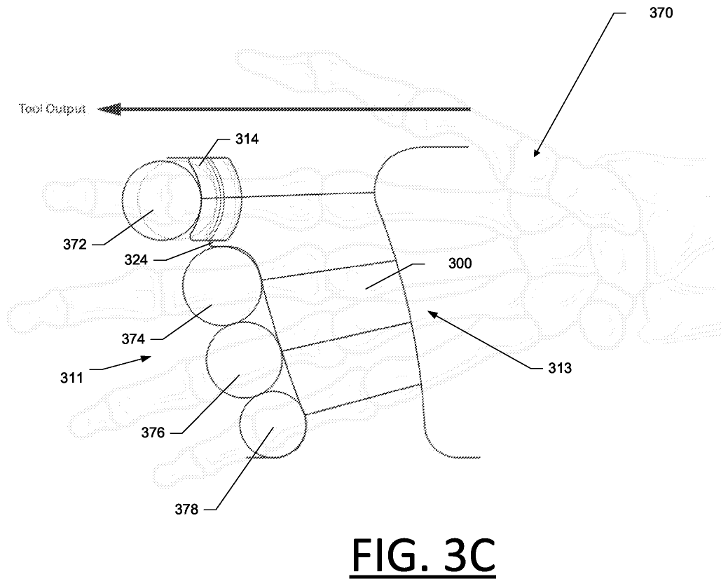

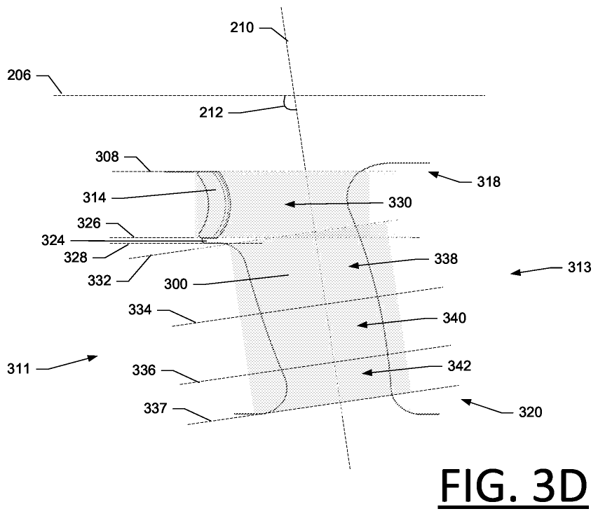

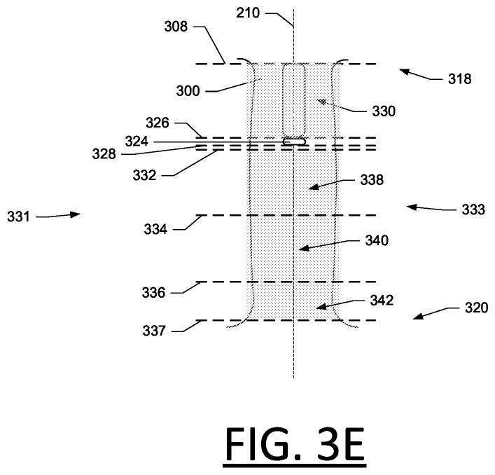

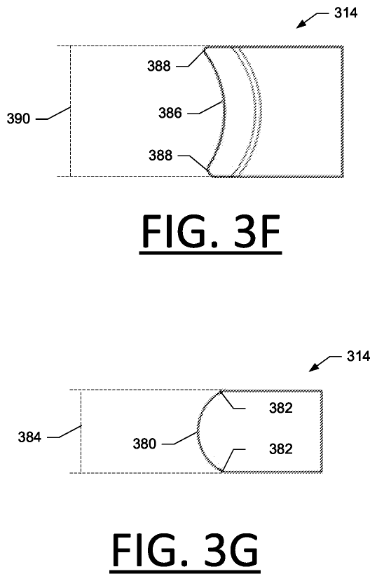

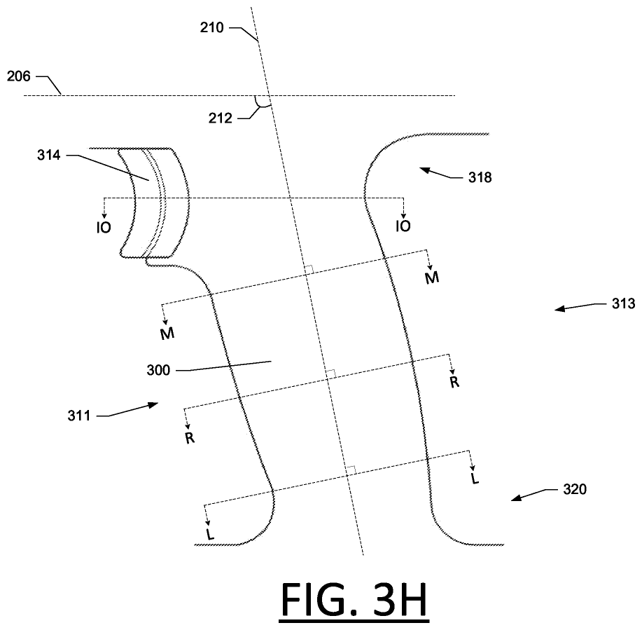

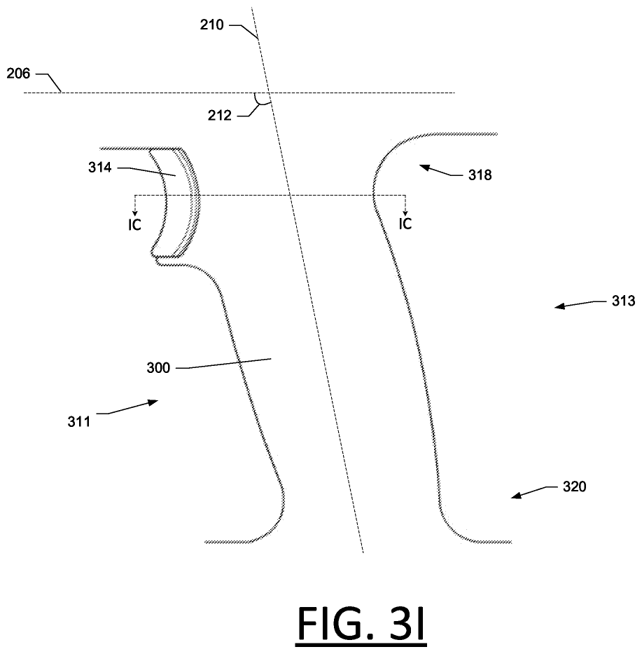

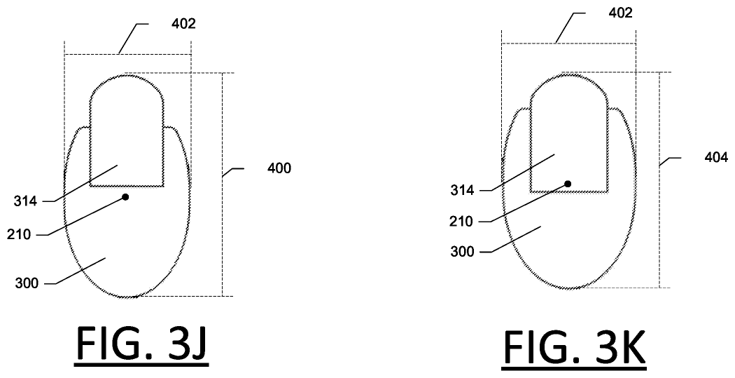

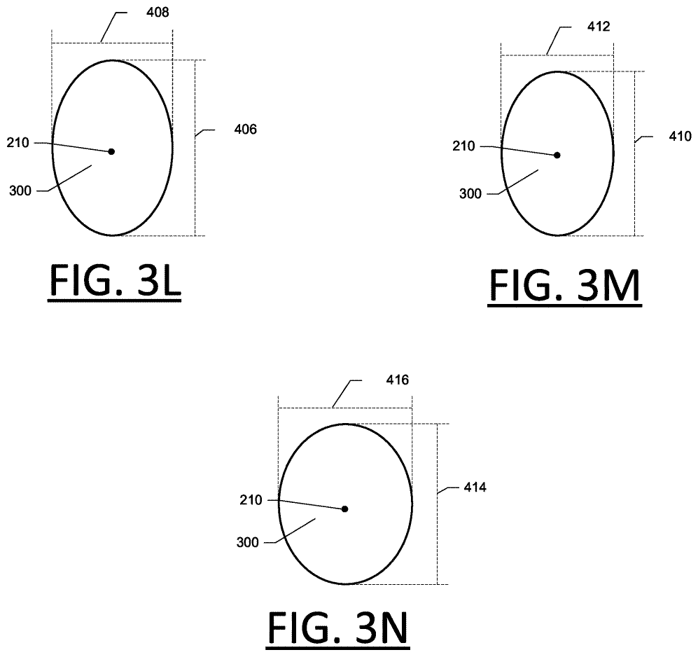

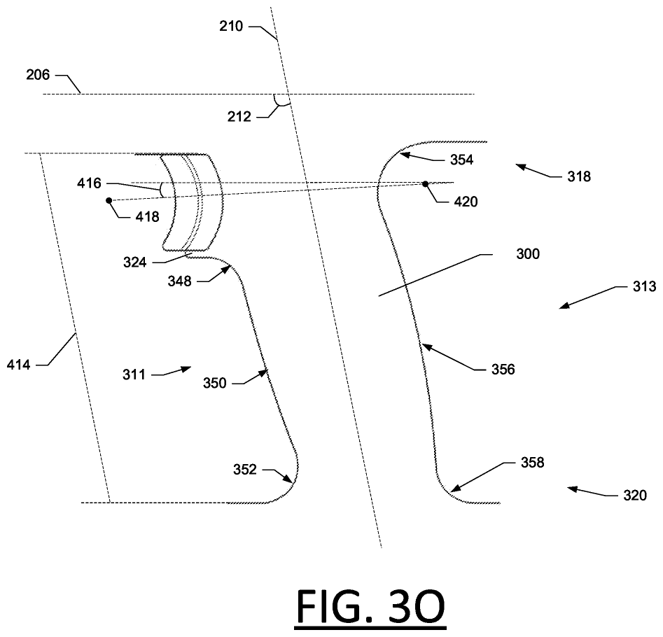

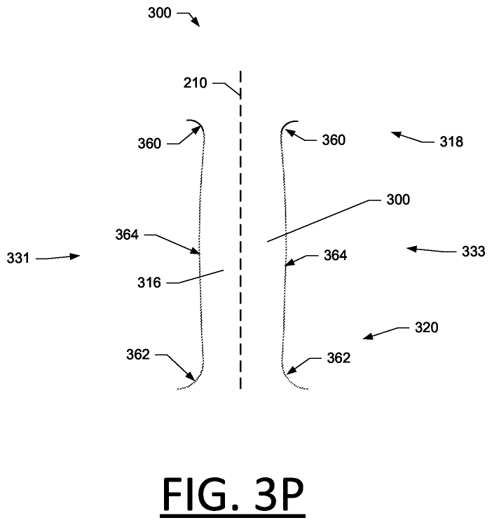

Having introduced various cross-sectional portions and curvatures of the handgrip 216 in the context of an example power tool 200, a further description of these parameters in association with another handgrip 300 is provided. The handgrip 300 may be embodied as the handgrip 216 in some example embodiments. Some or all of the specific parameters described with respect to the handgrip 300 may be implemented in the context of the handgrip 216. The handgrip 300 is generally described in isolation from a power tool for comprehension of the concepts associated with the various lengths, curvatures, etc. The handgrip 300 is described with reference to the drive axis 206, the handgrip axis 210, and the handgrip axis angle 212 as if it is implemented in the same context, with reference to the power tool 200, as the handgrip 216. As such, for context, FIGS. 3A and 3B are described as if the handgrip 300 extends from a power tool body along the handgrip axis 210 and relative to the drive axis 206 at the handgrip axis angle 212, as described above. Aspects of the ergonomic analysis and determinations described above were used in developing the specific parameter values used in the design of the example embodiments described below.

With reference to FIG. 3A, the handgrip 300 is defined by grip front 311, a grip back 313, a grip top 318, and a grip bottom 320, similar to the handgrip 216. Further, on the grip front 311, the handgrip 300 may comprise a trigger 314 and a trigger transition protrusion 324. With reference to FIG. 3B showing the front view of the handgrip 300, the handgrip 300 is defined by a first grip side 331 and a second grip side 333. As shown in FIG. 3B, the handgrip axis 210 is disposed central to handgrip 300 when viewed from the front.

FIG. 3C illustrates a side view of the handgrip 300 in relation with the bone structure of a user's hand 370 and circular indications of the user's fingers in a gripping position on the handgrip 300. The user's index finger 372 is shown in engagement with the trigger 314. As mentioned above, the index finger 372 may be defined as having a radius of 25 mm. When the handgrip 300 is gripped, the index FIG. 372 may be seated within the concave vertical curvature of the trigger 314, when viewed from the side. Additionally, the user's middle finger 374 is shown in position immediately below the trigger transition protrusion 324, and the user's middle finger 374 may be defined as having a radius of 25 mm. The middle finger 374 is positioned within a concave curvature associated the handgrip 300 transitioning into the trigger portion (or the index finger cross-sectional portion). Further, the user's ring finger 376 is shown in position below the user's middle finger 374, and the user's ring finger 376 may be defined as having a radius of 24 mm. The ring finger 376 is positioned on the convex middle portion of the handgrip 300. Finally, the user's little finger 378 is shown in position below the user's ring finger 376, and the user's little finger 378 may be defined as having a radius of 21 mm. The user's little finger 378 is positioned within a concave curvature associated with the handgrip 300 transitioning into the battery interface portion.

Now referring to FIGS. 3D and 3E, various cross-sectional portions of the handgrip 300 are defined and shown (similar to those shown and described with respect to FIGS. 2B and 2C) in light of the hand to handgrip correlation shown in FIG. 3C. As such, FIGS. 3D and 3E, provide another side view and a front view of the handgrip 300, respectively, with cross-sectional portions of the handgrip 300 defined. In this regard, an index finger cross-sectional portion 330, a middle finger cross-sectional portion 338, a ring finger cross-sectional portion 340, and a little finger cross-sectional portion 342 are shown. These cross-sectional portions are shown within the side view of FIG. 3D relative the grip front 311 and grip back 313, and within the front view of FIG. 3E relative to a first grip side 331 (disposed between the grip front 311 and the grip back 313) and a second grip side 333, opposite the first grip side 331.

The index finger cross-sectional portion 330 may be defined as a volume of the handgrip 300 that is between the trigger top plane 308 and a trigger bottom plane 326. The trigger top plane 308 may be defined similar to the trigger top plane 208 as the plane through the handgrip 300 defined at the top surface of the trigger 314 and parallel to the drive axis 206. The trigger bottom plane 326 may be a plane through the handgrip 300 that is aligned with a bottom surface of the trigger 314. According to some example embodiments, the bottom surface of the trigger 314 and the trigger bottom plane 326 may be disposed parallel to the drive axis 206, and, as such, the index finger cross-sectional portion 330 may be generally parallel to the drive axis 306.

On the grip front 311 below the trigger 314, the handgrip 300 may include the trigger transition protrusion 324. Like the trigger transition protrusion 224, the trigger transition protrusion 324 may be protruding member that extends in a forward direction immediately adjacent to the bottom surface of the trigger 314. The trigger transition protrusion 324 operates to prevent the user's middle finger from resting on the bottom surface of the trigger 314 and potentially being pinched when the user actuates the trigger 314. As such, the user's middle finger may rest on the bottom side of the trigger transition protrusion 324 to prevent the user's middle finger from touching the trigger 314 when the user is gripping the handgrip 300. A front face of the trigger transition protrusion 324 may extend from the trigger bottom plane 326 to a bottom surface of the trigger transition protrusion 324 to define a trigger transition bottom plane 328 that is generally parallel to the drive axis 206. Similar to the trigger transition protrusion 224, the height of the trigger transition protrusion 324 may be preferably about 2 mm, but may be within a range of about 1 mm to 3 mm.

Intersecting with the trigger transition bottom plane 228 and disposed below the front face of the of the trigger transition protrusion 224, a middle finger top plane 332 may be defined that is perpendicular or orthogonal to the handgrip axis 210. Again, based on the research described above, a middle finger diameter may be selected to be about 25 mm. As such, about 25 mm below the middle finger top plane 232, a ring finger top plane 234 (or the middle finger bottom plane) may be defined that is also perpendicular or orthogonal to handgrip axis 210. The volume of the handgrip 300 between the middle finger top plane 332 and the ring finger top plane 334 may define the middle finger cross-sectional portion 338.

Additionally, a ring finger diameter may be selected to be about 24 mm as described above. As such, about 24 mm below the ring finger top plane 334, a little finger top plane 336 (or the ring finger bottom plane) may be defined that is also perpendicular or orthogonal to handgrip axis 210. The volume of the handgrip 300 between the ring finger top plane 334 and the little finger top plane 336 may define the ring finger cross-sectional portion 340. Additionally, a little finger diameter may be selected to be about 21 mm. As such, about 21 mm below the little finger top plane 336, a handgrip bottom plane 337 may be defined that is also perpendicular or orthogonal to handgrip axis 210. The volume of the handgrip 300 between the little finger top plane 336 and the handgrip bottom plane 337 may define the little finger cross-sectional portion 342.

Referring to FIGS. 3F and 3G, parameters for the sizing and curvature of the trigger 314 are described that employ regional ergonomics as described herein. In this regard, FIG. 3F provides a side view of the trigger 314. A first parameter for the trigger 314 is the height 390 of the trigger 314, which extends generally perpendicular to the drive axis 206 when the trigger 314 is assembled in the handgrip 300 of a power tool. According to some example embodiments, the height 390 of the trigger 314 may be between about 24 mm and 28 mm, and preferably about 26 mm.

Additionally, the trigger front surface that engages with the user's index finger may have a vertical concave curvature 386 (when viewed from the grip side 331 or 333). The vertical concave curvature 386 of the trigger 314 may have a radius of curvature (referred to as the trigger vertical concave radius of curvature) of between about 18 mm to 22 mm, and preferably about 20 mm. Additionally, on the trigger front surface, edges 388 at the top and bottom of the surface may be rounded and have a convex curvature. The radius of curvature of the edges 388 (or the trigger edge radius of curvature) may be between about 1 mm to 2 mm, and preferably about 1.5 mm.

Referring to FIG. 3G which illustrates a top view of the trigger 314, a width and horizontal curvatures of the trigger 314 can be described. The width 384 extending horizontally across the trigger 314 (from side to side parallel to the drive axis 206) may be about 16 mm to 20 mm, and preferably about 18 mm. Also, at a central portion of the trigger 314, a horizontal convex curvature 380 may be included to improve index finger engagement. This central horizontal convex curvature 380 may have a radius of curvature of between about 8 mm to 12 mm, and preferably about 10 mm. Also, the edges 382 of the horizontal convex front face of the trigger 314 may have a different curvature that is also convex. In this regard, the radius of curvature at the edges 382 (or the horizontal edge convex radius of curvature) may be about 4 mm to 6 mm, and preferably about 5 mm.

Having defined various cross-sectional portions of the handgrip 300 and some parameters of the trigger 314, reference is now made to FIGS. 3H and 3I to define cross-sections of the handgrip 300, as shown in FIGS. 3J to 3N, and parameters thereof. As described above, such parameters have been determined through regional ergonomic analysis. In this regard, referring specifically to FIG. 3H, cross-sections are defined within each of the cross-sectional portions described with respect to FIGS. 3D and 3E. In this regard, an index finger cross-section IO-IO as shown in FIG. 3H may be defined within the index finger cross-sectional portion 330, when the trigger 314 is in the extended position due to being released by a user's index finger. Further, an index finger cross-section IC-IC as shown in FIG. 3I may be defined within the index finger cross-sectional portion 330, when the trigger 314 is in the depressed position due to a depressing force being applied to the trigger 314 by a user's index finger. Similar to the index finger cross-sectional portion 330, the index finger cross-section IO-IO and the index finger cross-section IC-IC are oriented to be parallel to the drive axis 206. Additionally, the index finger cross-section IO-IO and the index finger cross-section IC-IC are taken at the apex of the trigger vertical curvature 386.

Additionally, with reference again to FIG. 3H, a middle finger cross-section M-M may be defined within the middle finger cross-sectional portion 338, (for example, about 28 mm below the index finger cross-section IO-IO). Similar to the middle finger cross-sectional portion 330, the middle finger cross-section M-M is oriented to be perpendicular or orthogonal to the handgrip axis 210. A ring finger cross-section R-R may be defined within the ring finger cross-sectional portion 340, (for example, about 25 mm below the middle finger cross-section M-M). Similar to the ring finger cross-sectional portion 340, the ring finger cross-section R-R is oriented to be perpendicular or orthogonal to the handgrip axis 210. Finally, a little finger cross-section L-L may be defined within the little finger cross-sectional portion 342, (for example, about 23 mm below the ring finger cross-section R-R). Similar to the little finger cross-sectional portion 342, the little finger cross-section L-L is oriented to be perpendicular or orthogonal to the handgrip axis 210.

FIG. 3J illustrates the index finger cross-section taken at IO-IO of FIG. 3H. As shown, the cross-section IO-IO is generally a partial ellipse shape due to the cross-section being taken through the trigger 314 and a portion of the handgrip 300. The partial ellipse shape has a center at the handgrip axis 210. Additionally, the partial ellipse has a minor axis 402 with a minor axis length of about 29 mm to 33 mm, and preferably 31 mm. With the trigger 314 in the extended position, a trigger extended length 400 defined from a front surface of the trigger 314 to an apex of the partial ellipse opposite the trigger 314 may be about 53 mm to 57 mm, and preferably 55 mm. The partial ellipse minor axis length and the trigger extended length have been derived based on a factor of twenty percent of the index finger length based on studies of the US, Latin American, and Chinese populations. As described above, according to some example embodiments, based on the twenty-percent of the index finger length, a circumference of an ellipse may be defined with a minor axis to major axis ratio of 1:1.25. According to some example embodiments, the minor axis to major axis ratio may be with a range from 1:1.20 to 1:1.32. By selecting the trigger extended length as provided herein, a more central portion of the user's index finger is used to actuate the trigger 314, rather than a tip portion of the user's finger, which can be less comfortable and impose strain on the tendons of the index finger.

FIG. 3J illustrates the index finger cross-section taken at IC-IC of FIG. 3I. As shown, the cross-section IC-IC is also generally a partial ellipse shape due to the cross-section being taken through the trigger 314 and a portion of the handgrip 300. Since the cross-section IC-IC is in the same position as the cross-section IO-IO, albeit with the trigger 314 in the depressed position, the cross-section IC-IC is a partial ellipse shape that has a center at the handgrip axis 210. Additionally, the partial ellipse has the minor axis 402 with the minor axis length of about 29 mm to 33 mm, and preferably 31 mm. With the trigger 314 in the depressed position, a trigger-depressed length 404 defined from a front surface of the trigger 314 to an apex of the partial ellipse opposite the trigger 314 may be about 48 mm to 52 mm, and preferably 50 mm. The partial ellipse minor axis length and the trigger-depressed length have been derived based on a factor of twenty percent of the index finger length based on studies of the US, Latin American, and Chinese populations. Again, as described above, based on the twenty-percent of the index finger length, a circumference of an ellipse may be defined with a minor axis to major axis ratio of 1:1.25. According to some example embodiments, the minor axis to major axis ratio may be with a range from 1:1.20 to 1:1.32. By selecting the trigger-depressed length as provided herein, a more central portion of the user's index finger is again used to actuate the trigger 314, rather than a tip portion of the user's finger, which can be less comfortable and impose strain on the tendons of the index finger.

FIG. 3L illustrates the middle finger cross-section taken at M-M of FIG. 3H. As shown, the cross-section M-M is generally an ellipse shape (i.e., first ellipse shape) due to the cross-section being taken through a portion of the handgrip 300. The cross-section M-M is therefore a first ellipse shape corresponding to the middle finger and that has a center at the handgrip axis 210. Additionally, the first ellipse shape has the minor axis 408 with the minor axis length of about 31 mm to 35 mm, and preferably 33 mm. The first ellipse shape has the major axis 406 with the major axis length of about 41 mm to 45 mm, and preferably 43 mm. According to some example embodiments, the first ellipse minor axis length and the first ellipse major axis length have a respective ratio of about 1:1.25 (or within a range of about 1:20 to 1:1.32) that result in a circumference based on twenty percent of the middle finger length that optimizes grip strength based on studies of the US, Latin American, and Chinese populations.

FIG. 3M illustrates the ring finger cross-section taken at R-R of FIG. 3H. As shown, the cross-section R-R is generally an ellipse shape (i.e., second ellipse shape) due to the cross-section being taken through a portion of the handgrip 300. The cross-section R-R is therefore a second ellipse shape corresponding to the ring finger and has a center at the handgrip axis 210. Additionally, the second ellipse shape has the minor axis 412 with the minor axis length of about 30 mm to 34 mm, and preferably 32 mm. The second ellipse shape has the major axis 410 with the major axis length of about 40 mm to 44 mm, and preferably 42 mm. According to some example embodiments, the second ellipse minor axis length and the second ellipse major axis length have a respective ratio of about 1:1.25 (or within a range of about 1:20 to 1:1.32) that result in a circumference based on twenty percent of the ring finger length that optimizes grip strength based on studies of the US, Latin American, and Chinese populations.

FIG. 3N illustrates the ring finger cross-section taken at L-L of FIG. 3H. As shown, the cross-section L-L is generally an ellipse shape (i.e., third ellipse shape) due to the cross-section being taken through a portion of the handgrip 300. The cross-section L-L is therefore a third ellipse shape corresponding to the little finger and has a center at the handgrip axis 210. Additionally, the third ellipse shape has the minor axis 416 with the minor axis length of about 29 mm to 33 mm, and preferably 31 mm. The third ellipse shape has the major axis 410 with the major axis length of about 36 mm to 40 mm, and preferably 38 mm. According to some example embodiments, the third ellipse minor axis length and the third ellipse major axis length have a respective ratio of about 1:1.25 (or within a range of about 1:20 to 1:1.32) that result in a circumference based on twenty percent of the little finger length that optimizes grip strength based on studies of the US, Latin American, and Chinese populations.

Now referring to FIGS. 3O and 3P, a side view and a front view of the handgrip 300, respectively, are shown with reference to various curvature parameters of the handgrip 300. In this regard, with reference to FIG. 3O, curvatures of the grip front 311 and the grip back 313 are defined.

On the grip front 311 and on the bottom side of the trigger transition protrusion 324, a concave rounded portion 348 is defined that has a grip front upper concave radius of curvature that is within the middle finger cross-sectional portion 838. The grip front upper concave radius of curvature may be about 8 mm to 12 mm, and preferably 10 mm. Also on the grip front 311 and at the grip bottom 320, a concave curvature 352 is defined within the little finger cross-sectional portion 342 at the transition to the battery interface with that curvature being defined by a grip front lower radius of curvature. The grip front lower concave radius of curvature may be about 8 mm to 12 mm, and preferably 10 mm. Further, a convex curvature 350 is defined on a middle portion of the grip front 311 with the middle finger cross-sectional portion 338 and the ring finger cross-sectional portion 340 that is referred to as the grip front middle convex radius of curvature. The grip front middle convex radius of curvature may be about 280 mm to 320 mm, and preferably 300 mm.

On the grip back 313 and at the grip top 318, on a bottom side of the transition from the body of the power tool within the index finger cross-sectional portion 330, a concave rounded portion 354 is defined that has a grip back upper concave radius of curvature. The grip back upper concave radius of curvature may be about 12 mm to 16 mm, and preferably 14 mm. Also, on the grip back 313 and at the grip bottom 320, on a top side of the transition from the handgrip 300 to the battery interface within the little finger cross-sectional portion 342, a concave rounded portion 358 is defined that has a grip back lower concave radius of curvature. The grip back lower concave radius of curvature may be about 8 mm to 12 mm, and preferably 10 mm. Further, a convex curvature 356 is defined on a middle portion of the grip back 313 within the middle finger cross-sectional portion 338 and the ring finger cross-sectional portion 340 that is referred to as the grip back middle convex radius of curvature. The grip back middle convex radius of curvature may be about 210 mm to 250 mm, and preferably 230 mm.

Additionally, with reference to FIG. 30, other parameters for the ergonomic design of the handgrip 300 are shown. In this regard, a grip front height 414 may be defined that is measured parallel to the handgrip axis 210. The grip front height 414 may extend from the grip top 318, and more specifically a top surface of the trigger 314 (aligned with the trigger top plane 308), to the grip base 320, and more specifically aligned with an end of the curvature of the grip front lower concave curvature 352. According to some example embodiments, this grip front height 414 may be about 90 mm to 110 mm, and preferably 100 mm. Additionally, an angular relationship may exist between a center of curvature 418 of the vertical concave curvature of the trigger 314, when the trigger 314 is extended, and the center of curvature 420 of the grip side upper concave radius of curvature. In this regard, a line drawn through the extended trigger vertical center of curvature 418 and the back grip upper center of curvature 420 may intersect the drive axis 206 (and a line parallel to the drive axis 206) at an angle 416 of about two degrees.

Referring to FIG. 3P, curvatures on the sides of the handgrip 300 may be defined. In this regard, the handgrip 300 (similar to handgrip 216) may have bilateral symmetry, according to some example embodiments, such that the curvatures on the first grip side 331 may be the same as the curvatures to the second grip side 333. In this regard, the surfaces of the grip sides may define a grip side upper concave portion 360 in the index finger cross-sectional portion 330 that has a grip side upper concave radius of curvature at grip top 318. The grip side upper concave radius of curvature may be about 12 mm to 16 mm, and preferably 14 mm. Additionally, a convex curvature is defined on a middle convex portion 364 of the grip sides 331, 333, within the middle finger cross-sectional portion 338 and the ring finger cross-sectional portion 340 that has a radius of curvature referred to as the grip side middle radius of curvature. The grip side middle radius of curvature may be about 450 mm to 550 mm, and preferably 500 mm. Additionally, the surfaces of the grip sides may define a grip side lower concave portion 362 in the little finger cross-sectional portion 342 that has a grip side lower concave radius of curvature at grip bottom 362. The grip side lower concave radius of curvature may be about 8 mm to 12 mm, and preferably 10 mm.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A power tool comprising:
a body configured to house a motor and a drive head rotationally coupled to the motor, the drive head being rotatable about a drive axis, the drive head being disposed on a front of the power tool, the power tool also having a back which is disposed opposite of the front;
a handgrip extending from a bottom of the body and a grip top along a handgrip axis to a grip bottom; the handgrip axis intersecting with the drive axis; the handgrip having a grip front facing the front, a grip back facing the back, a first grip side disposed between the grip front and the grip back, and a second grip side disposed between the grip front and the grip back and opposite the first grip side; the handgrip axis extending at an oblique angle to the drive axis; and
a trigger configured to be depressible between an extended position and a depressed position by an index finger such that the trigger actuates along a trigger actuating direction that is substantially parallel to the drive axis and intersects with the handgrip axis;
wherein the handgrip comprises:
an index finger cross-sectional portion at the grip top, the trigger being disposed within the index finger cross-sectional portion;
a middle finger cross-sectional portion disposed below the index finger cross-sectional portion;
a ring finger cross-sectional portion disposed below the middle finger cross-sectional portion; and
a little finger cross-sectional portion disposed below the ring finger cross-sectional portion;
wherein the handgrip has a partial ellipse shape at an index finger cross-section taken through the trigger and parallel to the drive axis in the index finger cross-sectional portion, the partial ellipse shape having a partial ellipse shape minor axis length that is within a range of about 29 millimeters (mm) to 33 mm;
wherein the handgrip has a first ellipse shape at a middle finger cross-section taken perpendicular to the handgrip axis in the middle finger cross-sectional portion, the first ellipse shape having a first ellipse shape minor axis length that is greater than the partial ellipse shape minor axis length;
wherein the handgrip has a second ellipse shape at a ring finger cross-section taken perpendicular to the handgrip axis in the ring finger cross-sectional portion, the second ellipse shape having a second ellipse shape minor axis length that is greater than the partial ellipse shape minor axis length and less than the first ellipse shape minor axis length; and
wherein the handgrip has a third ellipse shape at a little finger cross-section taken perpendicular to the handgrip axis in the little finger cross-sectional portion, the third ellipse shape having a third ellipse shape minor axis length that is less than the first ellipse shape minor axis length and the second ellipse shape minor axis length.

2. The power tool of claim 1, wherein a trigger-depressed length from the trigger to an apex of the partial ellipse shape opposite the trigger is about 48 mm to 52 mm; and
wherein a trigger extended length from the trigger to the apex of the partial ellipse shape opposite the trigger is about 53 mm to 57 mm.

3. The power tool of claim 1, wherein a first ellipse shape major axis length of the first ellipse shape is about 41 mm to 45 mm;
wherein a second ellipse shape major axis length of the second ellipse shape is about 40 mm to 44 mm; and
wherein a third ellipse shape major axis length of the third ellipse shape is about 36 mm to 40 mm.

4. The power tool of claim 1, wherein a trigger-depressed length from the trigger to an apex of the partial ellipse shape opposite the trigger is about 48 mm to 52 mm;
wherein a trigger extended length from the trigger to the apex of the partial ellipse shape opposite the trigger is about 53 mm to 57 mm;
wherein a first ellipse shape major axis length of the first ellipse shape is about 41 mm to 45 mm;
wherein a second ellipse shape major axis length of the second ellipse shape is about 40 mm to 44 mm; and
wherein a third ellipse shape major axis length of the third ellipse shape is about 36 mm to 40 mm.

5. The power tool of claim 1, wherein the handgrip axis extends at the oblique angle toward the back of the power tool, the oblique angle being about 72 to 78 degrees relative to the drive axis.

6. The power tool of claim 1, wherein a width of the trigger is about 16 mm to 20 mm.

7. The power tool of claim 1, wherein a trigger vertical concave radius of curvature of a finger engaging front surface of the trigger is about 18 mm to 22 mm; and
wherein a trigger height of the trigger is about 24 mm to 28 mm.

8. The power tool of claim 1, wherein a grip front upper concave radius of curvature of a front surface of the handgrip within the middle finger cross-sectional portion is about 8 mm to 12 mm.

9. The power tool of claim 1, wherein a grip front middle convex radius of curvature of a front surface of the handgrip within the ring finger cross-sectional portion is about 280 mm to 320 mm; and
wherein a grip front lower concave radius of curvature of the front surface of the handgrip within the little finger cross-sectional portion is about 8 mm to 12 mm.

10. The power tool of claim 1, wherein a grip back upper concave radius of curvature of a back surface of the handgrip within the index finger cross-sectional portion is about 12 mm to 16 mm;
wherein a grip back middle convex radius of curvature of the back surface of the handgrip within the ring finger cross-sectional portion is about 210 mm to 250 mm; and
wherein a grip back lower concave radius of curvature of the back surface of the handgrip within the little finger cross-sectional portion is about 8 mm to 12 mm.

11. The power tool of claim 1, wherein a grip side upper concave radius of curvature of a side surface of the handgrip within the index finger cross-sectional portion is about 12 mm to 16 mm;
wherein a grip side middle convex radius of curvature of the side surface of the handgrip within the ring finger cross-sectional portion is about 450 mm to 550 mm; and
wherein a grip back lower concave radius of curvature of the back surface of the handgrip within the little finger cross-sectional portion is about 8 mm to 12 mm.

12. The power tool of claim 1, wherein a grip side upper concave radius of curvature of a side surface of the handgrip within the index finger cross-sectional portion is about 12 mm to 16 mm;
wherein a trigger vertical concave radius of curvature of a finger engaging front surface of the trigger is about 18 mm to 22 mm;
wherein the back grip upper concave radius of curvature defines a back grip upper center of curvature and, when the trigger is in an extended position, the trigger vertical concave radius of curvature defines an extended trigger vertical center of curvature; and
wherein a line through the back grip upper center of curvature and the extended trigger vertical center of curvature intersects the drive axis at an angle of about two degrees.

13. A power tool comprising:
a body configured to house a motor and a drive head rotationally coupled to the motor, the drive head being rotatable about a drive axis, the drive head being disposed on a front of the power tool, the power tool also having a back which is disposed opposite of the front;
a handgrip extending from a bottom of the body and a grip top along a handgrip axis to a grip bottom; the handgrip axis intersecting with the drive axis; the handgrip having a grip front facing the front, a grip back facing the back, a first grip side disposed between the grip front and the grip back, and a second grip side disposed between the grip front and the grip back and opposite the first grip side; the handgrip axis extending at an oblique angle to the drive axis; and
a trigger configured to be depressible between an extended position and a depressed position by an index finger such that the trigger actuates along a trigger actuating direction that is substantially parallel to the drive axis and intersects with the handgrip axis;
wherein a trigger-depressed length from the trigger to an apex of the partial ellipse shape opposite the trigger is about 48 millimeters (mm) to 52 mm;
wherein a trigger extended distance from the trigger to the apex of the partial ellipse shape opposite the trigger is about 53 mm to 57 mm;
wherein a width of the trigger is between about 16 mm to 20 mm;
wherein a trigger height of the trigger is about 24 mm to 28 mm;
wherein a trigger vertical concave radius of curvature of a finger engaging front surface of the trigger is about 18 mm to 22 mm.

14. The power tool of claim 13, wherein the handgrip axis extends at the oblique angle toward the back of the power tool, the oblique angle being about 72 to 78 degrees relative to the drive axis.

15. The power tool of claim 14, wherein wherein the handgrip comprises:
an index finger cross-sectional portion at the grip top, the trigger being disposed within the index finger cross-sectional portion;
a middle finger cross-sectional portion disposed below the index finger cross-sectional portion;
a ring finger cross-sectional portion disposed below the middle finger cross-sectional portion; and
a little finger cross-sectional portion disposed below the ring finger cross-sectional portion;
wherein the handgrip has a partial ellipse shape at an index finger cross-section taken through the trigger and parallel to the drive axis in the index finger cross-sectional portion, the partial ellipse shape having a partial ellipse shape minor axis length that is within a range of about 29 mm to about 33 mm;
wherein the handgrip has a first ellipse shape at a middle finger cross-section taken perpendicular to the handgrip axis in the middle finger cross-sectional portion, the first ellipse shape having a first ellipse shape minor axis length of about 31 mm to about 35 mm;
wherein the handgrip has a second ellipse shape at a ring finger cross-section taken perpendicular to the handgrip axis in the ring finger cross-sectional portion, the second ellipse shape having a second ellipse shape minor axis length of about 30 mm to 34 mm;
wherein the handgrip has a third ellipse shape at a little finger cross-section taken perpendicular to the handgrip axis in the little finger cross-sectional portion, the third ellipse shape having a third ellipse shape minor axis length of about 29 mm to 33 mm.

16. The power tool of claim 15, wherein a first ellipse shape major axis length of the first ellipse shape is about 41 mm to 45 mm;
wherein a second ellipse shape major axis length of the second ellipse shape is about 40 mm to 44 mm; and
wherein a third ellipse shape major axis length of the third ellipse shape is about 36 mm to 40 mm.

17. A power tool comprising:
a body configured to house a motor and a drive head rotationally coupled to the motor, the drive head being rotatable about a drive axis, the drive head being disposed on a front of the power tool with an opposite face being a back of the power tool;
a handgrip extending from a bottom of the body and a grip top along a handgrip axis to a grip bottom; the handgrip axis intersecting with the drive axis; the handgrip having a grip front facing the front, a grip back facing the back, a first grip side disposed between the grip front and the grip back, and a second grip side disposed between the grip front and the grip back and opposite the first grip side; the handgrip axis extending at an oblique angle to the drive axis; and
a trigger configured to be depressible between an extended position and a depressed position by an index finger such that the trigger actuates along a trigger actuating direction that is substantially parallel to the drive axis and intersects with the handgrip axis;
wherein the handgrip comprises:
an index finger cross-sectional portion at the grip top, the trigger being disposed within the index finger cross-sectional portion;
a middle finger cross-sectional portion disposed below the index finger cross-sectional portion;
a ring finger cross-sectional portion disposed below the middle finger cross-sectional portion; and
a little finger cross-sectional portion disposed below the ring finger cross-sectional portion;
wherein a grip front upper concave radius of curvature of a front surface of the handgrip within the middle finger cross-sectional portion is about 8 mm and 12 mm;
wherein a grip back upper concave radius of curvature of a back surface of the handgrip within the index finger cross-sectional portion is between about 12 mm and 16 mm.

18. The power tool of claim 17, wherein a grip front middle convex radius of curvature of a front surface of the handgrip within the ring finger cross-sectional portion is about 280 mm to 320 mm;
wherein a grip back middle convex radius of curvature of the back surface of the handgrip within the ring finger cross-sectional portion is about 210 mm to 250 mm.

19. The power tool of claim 18, wherein a grip front lower concave radius of curvature of the front surface of the handgrip within the little finger cross-sectional portion is about 8 mm to 12 mm;
wherein a grip back lower concave radius of curvature of the back surface of the handgrip within the little finger cross-sectional portion is about 8 mm to 12 mm.

20. The power tool of claim 19, wherein a grip side upper concave radius of curvature of a side surface of the handgrip within the index finger cross-sectional portion is about 12 mm to 16 mm;
wherein a grip side middle convex radius of curvature of the side surface of the handgrip within the ring finger cross-sectional portion is about 450 mm to 550 mm; and
wherein a grip back lower concave radius of curvature of the back surface of the handgrip within the little finger cross-sectional portion is about 8 mm to 12 mm.
